(19) United States
(12) Patent Application Publication
(10) Pub. No.: US 2010/0136910 A1
(43) Pub. Date: Jun. 3, 2010

(54) APPARATUS AND METHOD FOR DEVICE SEARCH FOR HIGH-SPEED BASED BLUETOOTH APPLICATIONS

(75) Inventors: Seong-hee LEE, Daejeon (KR); Il-Soon JANG, Daejeon (KR); Sangsung CHOI, Daejeon (KR); Seong Hee PARK, Daejeon (KR)

Correspondence Address: Jae Y. Park, Kile, Goekjian, Reed & McManus, PLLC, 1200 New Hampshire Ave. NW, Suite 570, Washington, DC, 20036, US

(73) Assignee: ELECTRONICS AND TELECOMMUNICATIONS RESEARCH INSTITUTE, Daejeon (KR)

(21) Appl. No.: 12/628,320

(22) Filed: Dec. 1, 2009

(30) Foreign Application Priority Data
Dec. 3, 2008 (KR) 10-2008-0122000
Apr. 15, 2009 (KR) 10-2009-0032926

(51) Int. Cl. H04B 7/00

(52) U.S. Cl. 455/41.2

(57) ABSTRACT

Provided are a device searching method of a Bluetooth application and an apparatus using the same. The apparatus includes an application unit that generates a command for searching a Bluetooth device in a surrounding area of the device searching apparatus, a stack unit that performs a Bluetooth device initialization process and processes the command generated in the application unit, a first module unit that searches first Bluetooth devices in the surrounding area of the device searching apparatus, and a second module unit that searches second Bluetooth devices in the surrounding area of the device searching apparatus.

### CROSS-REFERENCE TO RELATED APPLICATION

This application claims priority to and the benefit of Korean Patent Application Nos. 10-2008-0122000 and 10-2009-0032926 filed in the Korean Intellectual Property Office on Dec. 3, 2008 and Apr. 15, 2009, the entire contents of which are incorporated herein by reference.

### BACKGROUND OF THE INVENTION

(a) Field of the Invention

The present invention relates to a device search apparatus for a Bluetooth application and a method thereof.

(b) Description of the Related Art

The WiMedia MAC/PHY specification has been settled on as a standard of an ultra-wideband (UWB) communication method, which has been highlighted as a next generation wireless communication method. A standardization process for connecting application protocols has been carried out simultaneously for use of the application protocols based on the WiMedia MAC/PHY. In addition, a process for a method for providing a high-speed based service by using the UWB method for a low-speed Bluetooth application has also been simultaneously carried out. For this, the high-speed based Bluetooth method should be compatible with an existing Bluetooth method.

When searching a service type of a conventional Bluetooth device, the service type of the searched Bluetooth device could be checked by performing an additional message exchange by separately using a service discovery profile (SDP).

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a device searching method for a low-speed based Bluetooth application in current use to search not only low-speed based Bluetooth devices but also devices providing high-speed data services when the low-speed based Bluetooth application provides a high-speed based data service.

A device search apparatus that searches a Bluetooth device according to an exemplary embodiment of the present invention includes: an application unit that generates a command for searching a Bluetooth device in a surrounding area of the device searching apparatus; a stack unit that performs a Bluetooth device initialization process and processes the command generated in the application unit; a first module unit that searches a first Bluetooth device in the surrounding area of the device searching apparatus; and a second module unit that searches a second Bluetooth device in the surrounding area of the device searching apparatus.

A method of a device search apparatus for searching a Bluetooth device according to another exemplary embodiment of the present invention includes: performing initializing of a Bluetooth device of a predetermined type; generating an inquiry command according to an externally input device search command and broadcasting the generated inquiry command to Bluetooth devices in a surrounding area of the device search apparatus; checking device class factor values included in inquiry result response messages received from the surrounding Bluetooth devices; determining whether a Bluetooth device having transmitted the inquiry result response message is a first Bluetooth device or a second Bluetooth device based on the device class factor value; and if the Bluetooth device having transmitted the inquiry result response message is the second Bluetooth device, providing search information including information on a service type provided by the second Bluetooth device.

### BRIEF DESCRIPTION OF THE DRAWINGS

FIG. 1 is a configuration diagram of a low-speed based Bluetooth local device.

FIG. 2 is a configuration diagram of a device class factor.

FIG. 3 exemplarily shows a device search result through a device searching method for a general low-speed based Bluetooth application.

FIG. 4 is a configuration diagram of a high-speed based Bluetooth local device according to an exemplary embodiment of the present invention.

FIG. 5 is a flowchart of a device searching method through a device searching method for the high-speed based Bluetooth application according to the exemplary embodiment of the present invention.

FIG. 6 exemplarily shows a device search result through the device searching method for the high-speed based Bluetooth application according to the exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In addition, unless explicitly described to the contrary, the word “comprise” and variations such as “comprises” or “comprising” will be understood to imply the inclusion of stated elements but not the exclusion of any other elements

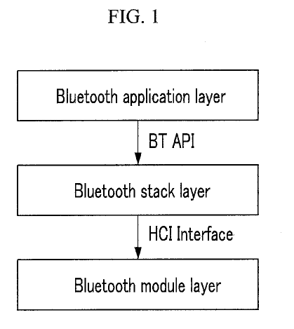

Before describing an exemplary embodiment of the present invention, a hierarchical structure and a function of a low-speed based Bluetooth technique will be described with reference to FIG. 1 to FIG. 4.

FIG. 1 is a configuration diagram of a general low-speed based Bluetooth local device.

As shown in FIG. 1, a hierarchical structure of the low speed-based Bluetooth device includes a Bluetooth application layer which is the uppermost layer, a Bluetooth stack layer, and a Bluetooth module layer which is the lowermost layer and that manages transmission/receiving of Bluetooth data corresponding to a physical layer.

Among the three layers, a Bluetooth device initialization process is performed through the Bluetooth stack layer for use of the Bluetooth device, and various Bluetooth commands are processed or newly generated to be processed. Bluetooth commands required to be processed are processed in the Bluetooth stack layer and the Bluetooth module layer through a host controller interface (HCI) interposed therebetween.

Therefore, the Bluetooth module layer transmits various commands received from the Bluetooth stack layer to a remote device, or transmits a processing result of a specific command received from the remote device to the Bluetooth stack layer. The Bluetooth stack layer communicates the processing result with the Bluetooth application layer through an API of the application layer. In this way, the processing results of the various commands are reported to the uppermost layer, that is, the Bluetooth application layer, so that a Bluetooth application of the Bluetooth application layer can control the Bluetooth device.

The Bluetooth application performs device search to search existence of Bluetooth devices in a surrounding area before attempting device connection for substantial data communication.

Among commands used in the Bluetooth stack layer, an Inquiry command is a command for searching the surrounding Bluetooth devices. When the Inquiry command is transmitted to the Bluetooth module layer from the Bluetooth stack layer through the host controller interface, the Bluetooth module layer processes the Inquiry command. In this case, a local device having requested the Inquiry command receives Inquiry result response messages from the surrounding devices.

In the Inquire result response message, factor information, that is, Class of Device, is included. The local Bluetooth application reads the factor information to check information on the searched surrounding Bluetooth devices. A structure of the Inquire result response message is as shown in Table 1.

TABLE 1

| Event | Event Code | Event Parameters |
|---|---|---|
| Inquiry Result | 0x02 | Num_Responses, |
| | | BD_ADDR[i], |
| | | Page_Scan_Repetition_Mode[i], |
| | | Reserved[i], |
| | | Reserved[i], |
| | | Class_of_Device[i], |
| | | Clock_Offset[i] |

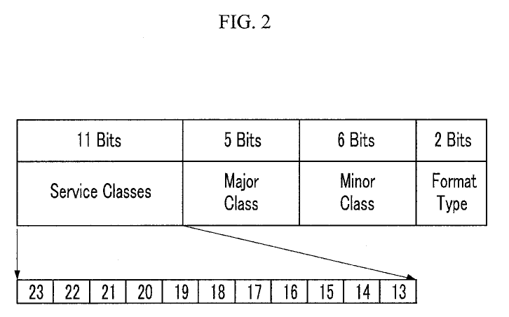

A structure of the Class of Device factor used for checking the searched Bluetooth devices will be described with reference to FIG. 2.

FIG. 2 is a configuration diagram of a general Class of Device.

As shown in FIG. 2, the Class of Device has a size of 24 bits, which is divided into 11 bits, 5 bits, 6 bits, and 2 bits for indicating respective information.

First, the 2-bit information indicates a format type field, and the Inquire command determines whether to continuously perform a device search until a response to the Inquire command is received or to perform a device search for a predetermined specific time period.

A minor class field represented by 6 bits and a major class field represented by 5 bits respectively inform a type of the searched surrounding Bluetooth device in detail. For example, the two fields inform whether the searched surrounding device is a communication device or an office device, and the two fields inform detailed information, for example, a type of the communication device or a type of the office device.

The service class represented by 11 bits indicates a type of service provided by the searched Bluetooth device. A detailed format of the service class is as shown in Table 2.

TABLE 2

| Bits | Service Types |
|---|---|
| 13 | Limited Discoverable Mode |
| 14 | Reserved |
| 15 | Reserved |
| 16 | Positioning |
| 17 | Networking |
| 18 | Rendering |
| 19 | Capturing |
| 20 | Object Transfer |
| 21 | Audio |
| 22 | Telephony |
| 23 | Information |

The 18-th bit value of the service class in Table 2 indicates a “rendering” service, and a device providing the rendering service includes a scanner or a printer. Thus, the rendering service is used in the printer and the scanner. The 22-nd bit value indicates a “telephony” service, and a device providing the telephony includes a headset device and the like.

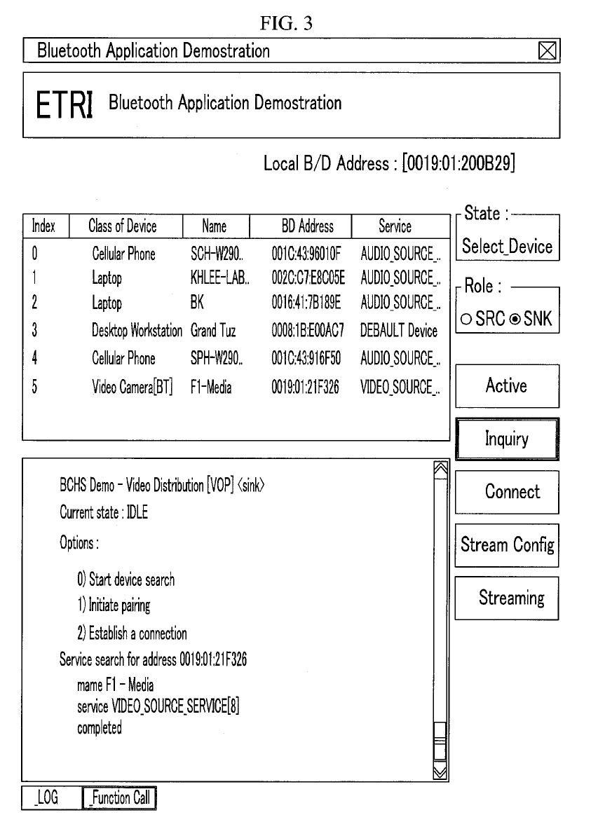

However, commercial Bluetooth applications check a service type of the Bluetooth device through a service discovery profile (SDP) shown in FIG. 3 rather than using the service class field. Each of the Bluetooth devices manages an SDP service, and contents of the respective service types are defined in the respective SDP servers.

Therefore, when a type of a Bluetooth device is checked through the inquiry command in the device searching process, a separate message for checking a service type by using the SDP is transmitted to a remote Bluetooth device in the next process. The remote Bluetooth device transmits a response message to inform the service type through the SDP server to a transmitting-side Bluetooth device in response to the received message.

When receiving the response message, the transmitting-side Bluetooth device finishes device searching and determines surrounding Bluetooth devices and service types provided thereby. A device searching result through the general device searching method described above is as shown in FIG. 3.

FIG. 3 exemplarily shows a device searching result through a device searching method of the general low-speed based Bluetooth application.

As shown in FIG. 3, a desired device is selected from among Bluetooth devices searched through device searching on a device search window, and device connection is attempted. When the device connection is established, Bluetooth application data can be exchanged through Bluetooth application.

The low-speed based Bluetooth application provides only a low-speed data service, and a low-speed voice service through a headset device is a main service provided by a currently used Bluetooth application. In preparation of a Bluetooth standard that can provide high-speed data services, comparability with an existing Bluetooth application should be provided, and therefore a function that can simultaneously search a high-speed based Bluetooth UWB (BT_UWB) device that can provide the high-speed data service through a device search method used by the low-speed based Bluetooth application is required.

A device searching method according to an exemplary embodiment of the present invention will now be described with reference to the drawings. In the exemplary embodiment of the present invention, a high-speed Bluetooth device hierarchical structure in which a high-speed based Bluetooth application is used will be described. The high-speed based Bluetooth application enables search of a BT_UWB device by using only a device class value without using SDP.

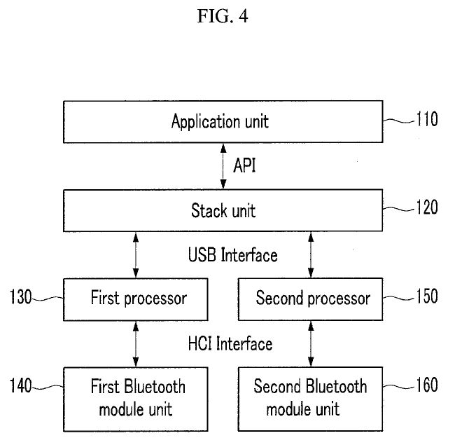

FIG. 4 is a hierarchical structure diagram of a high-speed based Bluetooth local device according to the exemplary embodiment of the present invention.

As shown in FIG. 4, the hierarchical structure according to the exemplary embodiment of the present invention includes an application unit (or, referred to as a Bluetooth application unit) 110, a stack unit (or, referred to as a Bluetooth stack unit) 120, a first module unit, and a second module unit. The first module unit includes a first processor 130 and a first Bluetooth module unit 140, and the second module unit includes a second processor 150 and a second Bluetooth module unit 160.

The Bluetooth application unit 110 generates various Bluetooth-related commands for searching peripheral Bluetooth devices in the module layer before attempting device connection for substantial data communication, and transmits the generated commands to the Bluetooth stack unit 120.

The Bluetooth stack unit 120 initializes a Bluetooth device for use of the Bluetooth device. The various Bluetooth-related commands transmitted from the Bluetooth application unit 110 may be processed in the Bluetooth stack unit 120, or, if the Bluetooth-related commands are not substantially processed in the Bluetooth application unit 110, the Bluetooth stack unit 120 may generate new commands to be processed in another layer.

The first module unit includes the first processor 130 and the first Bluetooth module unit 140 connected to the first processor 130 through a host controller interface, and is a process layer and a module layer used for searching low-speed based Bluetooth devices.

The first module unit 130 transmits the various commands received from the Bluetooth stack unit 120 to the first Bluetooth module unit 140 for broadcasting the same to a remote device, or transmits a processing result with respect to a specific command received from a peripheral remote device to the Bluetooth stack unit 120. The Bluetooth stack unit 120 communicates the processing result with the Bluetooth application unit 110 through an API of the application layer. In this way, the processing results of the various commands are reported to the Bluetooth application unit 110 in the uppermost layer so that Bluetooth applications can control Bluetooth devices.

The second module unit includes the second processor 150 and the second Bluetooth module unit 160 connected to the second processor 150 through the host controller interface, and is a process layer and a module layer used for searching a high-speed based Bluetooth device that uses a high-speed wireless communication method to be used for supporting high-speed data services. In the exemplary embodiment of the present invention, ultra-wideband communication (UWB) is exemplarily described as the high-speed wireless communication method, but it is not limited thereto.

The second processor 150 is connected to the Bluetooth stack unit 120 through a USB interface, and connects the Bluetooth stack unit 120 with the second Bluetooth module init 160 for providing the high-speed data service. The second processor 150 includes a protocol adaptation layer that converts Bluetooth application data to UWB data for processing the same.

Here, the protocol adaptation layer performs not only conversion of the Bluetooth application data to the UWB data for processing the same, but also understanding Bluetooth-related commands as Bluetooth modules for processing the same. That is, a module layer of the high-speed Bluetooth device is not a Bluetooth module but is a UWB module. Therefore, the Bluetooth-related commands received from the upper layer should be understood first. If not, the commands cannot be processed.

The second Bluetooth module unit 160 corresponds to a physical layer of substantial UWB, and is connected to the second processor 150 through the host controller interface. The second Bluetooth module unit 160 receives information of a service type that can be provided by a searched UWB device directly from the searched UWB, and stores the received service type information. By directly providing the information, service type information provided by the searched device can be transmitted to a device that has requested the service type information through only the inquiry process without performing an addition process for acquiring the service type information.

A service class field to be used for the device searching method according to the exemplary embodiment of the present invention among device class factors is as shown in Table 3.

TABLE 3

| Bits | Service Types |
|---|---|
| 13 | Limited Discoverable Mode |
| 14 | Reserved |
| 15 | UWB |
| 16 | Positioning |
| 17 | Networking |
| 18 | Rendering |
| 19 | Capturing |
| 20 | Object Transfer |
| 21 | Audio |
| 22 | Telephony |
| 23 | Information |

As shown in Table 2, the 14-th bit value and the 15-th bit value are reserved fields, and therefore, one of the two bit values is used for indicating whether a high-speed data service is supported or not for searching a high-speed based BT_UWB device. In the exemplary embodiment of the present invention, the 15-th bit value is exemplarily used as shown in Table 3, but it is not limited thereto.

If the 15-th bit value of a device class factor of a response message received from a device searched from a surrounding area is set to 1, and the Bluetooth application layer can perceive that the searched device is a BT_UWB device supporting a new high-speed service through the bit value.

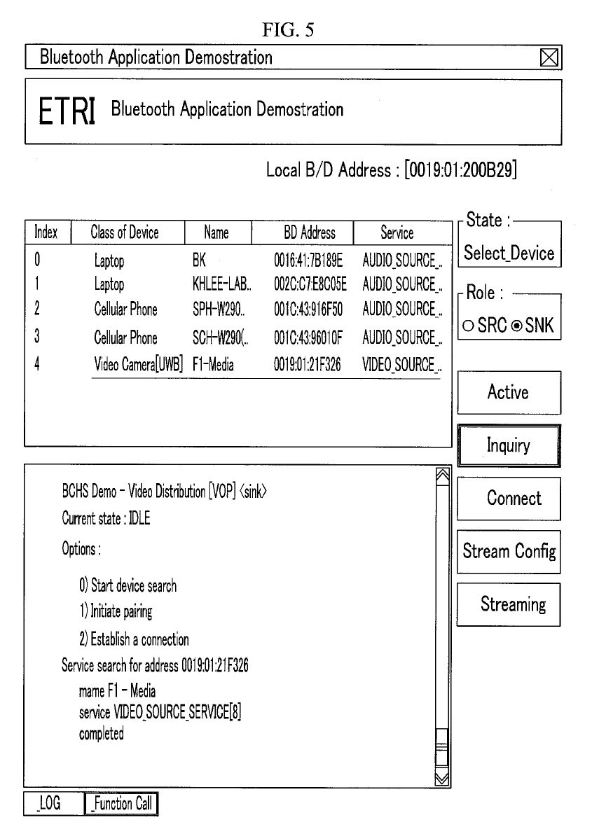

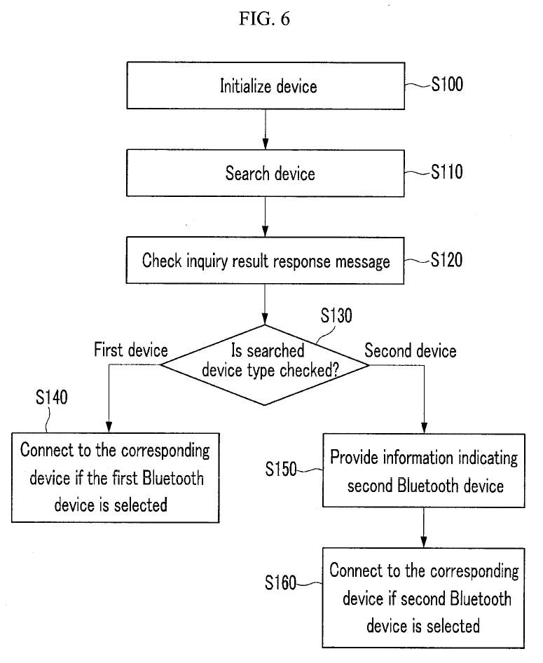

An example of substantial searching the high-speed based Bluetooth application device of a local device having the hierarchical structure of FIG. 4 and a process thereof will now be described with reference to FIG. 5 and FIG. 6.

FIG. 5 is a flowchart of a device searching method through a device searching method of a high-speed based Bluetooth application according to an exemplary embodiment of the present invention, and FIG. 6 is an example of a device search result through the device searching method of the high-speed based Bluetooth application according to the exemplary embodiment of the present invention.

Assume that a user selects “SRC” and “SNK” menus among menus in a Bluetooth application user interface (UI). The SRC and SNK respectively indicate a source device and a sink device, and they are selected for collecting selection information on whether to operate the corresponding local Bluetooth device as a source device for providing data or a sink device for receiving data.

When device selection is finished and an “Active” menu among the menus of the Bluetooth application UI is selected by the user, not only a Bluetooth device that has requested a device search but also turned-on devices in the surrounding area are initialized (S100). Completion of the initialization can be checked through the lower portion of the execution window and state information displayed on the upper right portion of the Bluetooth application UI. When the device initialization process is completed, the device search is performed (S110). When the user selects the Inquiry menu in the UI for the device search, the Bluetooth stack unit 120 transmits a Bluetooth command HCI_INQUIRY to the first and second processors 130 and 150 in the Bluetooth module unit through the host controller interface by using a low-speed based Bluetooth process.

The first and second processors 130 and 150 transmit the received inquiry command to the first and second Bluetooth module units 140 and 160 for broadcasting of the commands to Bluetooth devices in the surrounding area. When receiving the inquiry command, the Bluetooth devices in the surrounding area generate inquiry result response messages and transmit the generated messages to the Bluetooth device that has initially transmitted the inquiry command. Here, the inquiry result respond message includes service information provided by the corresponding Bluetooth device and a message format state.

The first and second module units 140 and 160 of the Bluetooth device that has received the inquiry result response message check a format state of the inquiry result response message (S120), and then report a process state with respect to the inquiry command to the Bluetooth application unit 110 which is the uppermost layer. When the Bluetooth application unit 110 determines that the inquiry command is normally processed, values included in the inquiry result response message are processed in the Bluetooth stack unit 120.

In this case, the Bluetooth stack unit 120 checks device class factor values used for the surrounding Bluetooth device search in the order of device class information and service class information. In addition, the Bluetooth stack unit 120 determines whether the searched Bluetooth device is a first Bluetooth device, that is, a low-speed based Bluetooth device, or a second Bluetooth device, that is, a Bluetooth device providing a high-speed based service (S130).

When checking the service class information, the Bluetooth stack unit 120 reports that the searched Bluetooth device is a BT_UWB device supporting a high-speed data service to the Bluetooth application unit 110 if a newly set value of the 15-th bit according to the exemplary embodiment of the present invention is checked. Through the result report, devices searched as a result of the device search through the inquiry command are listed on the upper portion of the execution window of the Bluetooth application UI as shown in FIG. 6.

As shown in FIG. 6, the high-speed data service supportable BT_UWB device searched through the service class field has an indication (e.g., UWB) that indicates that the device can support a high-speed data service after a device name (S150). When all the low-speed or high-speed based Bluetooth devices in the surrounding area are searched by using the conventional device searching method, the Bluetooth application determines a desired data service and attempts connection with a desired device (S140 and S160).

In this case, when the low-speed based Bluetooth device is selected, communication connection with a remote device is performed by using a Bluetooth module through the first processor 130 and the first Bluetooth module unit 140, which are the low-speed Bluetooth process layer as shown in FIG. 4. When the high-speed Bluetooth device is selected and connection with a high-speed communication device is desired, device connection is performed through the second processor 150 and the second Bluetooth module unit 160, which are the high-speed Bluetooth process layer.

According to the embodiments of the present invention, a Bluetooth device that can provide high-speed service can be searched by using a conventional low-speed device searching method without using a new device searching method. In addition, the Bluetooth device can be searched by performing only an inquiry process without using the SDP so that device search can be more efficiently performed.

The above-described embodiments can be realized through a program for realizing functions corresponding to the configuration of the embodiments or a recording medium for recording the program in addition to through the above-described device and/or method, which is easily realized by a person skilled in the art.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A device search apparatus searching a Bluetooth device, comprising:
an application unit that generates a command for searching a Bluetooth device in a surrounding area of the device searching apparatus;
a stack unit that performs a Bluetooth device initialization process and processes the command generated in the application unit;
a first module unit that searches a first Bluetooth device in the surrounding area of the device searching apparatus; and
a second module unit that searches a second Bluetooth device in the surrounding area of the device searching apparatus.

2. The device search apparatus of claim 1, wherein the first module unit comprises:
a first process layer that transmits the command processed in the stack unit and transmits a search result of the first Bluetooth device to the stack unit; and
a first Bluetooth module unit that searches the first Bluetooth device based on the command received from the first process layer, stores and provides service type information of the first Bluetooth device from device class factors included in a response message received from the first Bluetooth device.

3. The device search apparatus of claim 1, wherein the second module unit comprises:
a second process layer that transmits the command processed in the stack unit and transmits a search result of the second Bluetooth device to the stack unit; and
a second Bluetooth module unit that searches the second Bluetooth device based on the command received from the second process layer, stores and provides service type information of the second Bluetooth device from device class factors included in a response message received from the second Bluetooth device.

4. The device search apparatus of claim 3, wherein the second process layer further comprises a protocol adaptation unit that converts Bluetooth application data to ultra-wideband communication (UWB) data for processing the same.

5. The device search apparatus of claim 4, wherein the second Bluetooth device is a device providing services based on the UWB.

6. A method of a device search apparatus for searching a Bluetooth device, comprising:
performing initializing of a Bluetooth device of a predetermined type;
generating an inquiry command according to an externally input device search command and broadcasting the generated inquiry command to Bluetooth devices in a surrounding area of the device search apparatus;
checking device class factor values included in inquiry result response messages received from the surrounding Bluetooth devices;
determining whether a Bluetooth device having transmitted the inquiry result response message is a first Bluetooth device or a second Bluetooth device based on the device class factor value; and
if the Bluetooth device having transmitted the inquiry result response message is the second Bluetooth device, providing search information including information on a service type provided by the second Bluetooth device.

7. The method of claim 6, wherein the second Bluetooth device is a device providing an ultra-wideband (UWB) communication-based service.

8. The method of claim 6, wherein the service type information is included in service class field information included in the device class factor value.
